(19) United States
(12) Patent Application Publication
(10) Pub. No.: US 2013/0290423 A1
(43) Pub. Date: Oct. 31, 2013

(54) METHOD AND APPARATUS FOR USER GROUPING

(71) Applicant: INTERNATIONAL BUSINESS MACHINES CORPORATION, Amonk, NY (US)

(72) Inventors: Sheng Hua Bao, Beijing (CN); HongLei Guo, Beijing (CN); Zhili Guo, Bejing (CN); Zhong Su, Beijing (CN); Rui Wang, Beijing (CN); Hui Jia Zhu, Shanghai (CN)

(73) Assignee: International Business Machines Corporation, Amonk, NY (US)

(21) Appl. No.: 13/869,068

(22) Filed: Apr. 24, 2013

(30) Foreign Application Priority Data
Apr. 28, 2012 (CN) 201210134904.4

(51) Int. Cl. H04L 29/08

(52) U.S. Cl. CPC H04L 67/22
USPC 709/204

(57) ABSTRACT

A method and apparatus for user grouping on a network. The method includes: acquiring comments posted by a user on the network; extracting a set of triples from the comments, the set of triples including at least one triple comprising the user's concerned aspect, the user's sentiment on the aspect, and reasons for the sentiment; creating a characteristic representation of the comments based on the set of triples; and categorizing the user into a specific user group based on the characteristic representation. The apparatus corresponds to the method. Embodiments of the present invention can also process the obtained grouping information to obtain and display relevant information associated with user groups. With the method and apparatus of the embodiments of the present invention, user grouping can be better implemented.

### CROSS-REFERENCE TO RELATED APPLICATION

This application claims priority under 35 U.S.C. §119 from Chinese Patent Application No. 201210134904.4 filed Apr. 28, 2012, the entire contents of which are incorporated herein by reference.

### BACKGROUND OF THE INVENTION

The invention relates to the field of user grouping, and more specifically, to a method and apparatus for user grouping based on information in a network environment.

With the development of the Internet and the enrichment of functions thereof, more and more people are willing to share their own experiences and comments on the Internet. They may have different educational backgrounds, cultures, experiences, and preferences, and are given the same platform on the Internet to express their concerns and opinions. With an increasingly large number of Internet users, in many network application scenarios the ability to group or classify users in order to provide more targeted network-related products or services is desired.

For example in an electronic shopping website, User A may decide whether or not to buy a product by browsing other users' comments on the product. There can be a large number of comments on the same product and users with different backgrounds and requirements may have distinct comments on the same product. At this time, User A may want to be able to find sentiments given by users with similar backgrounds and requirements because such sentiments are more targeted and more valuable to User A. On the other hand, producers or manufacturers may want to know the comments and opinions of different types of users on their products to better improve their products. Internet shopping websites may want to know User A's background and requirements in order to better recommend a suitable product for User A. In the above example, all of the participants of Internet-based e-shopping websites want to be able to analyze users with different backgrounds and requirements. Therefore, if users can be grouped based on the users' backgrounds and requirements, then respective participants will be greatly helped in obtaining information of interest.

Some methods have been provided in existing network-related technologies for preliminary and simple grouping of network users. For example, users can often register personal profiles on the Internet that include their age, gender, address (location), family members, income, education background, work experience, hobbies, and so on. A rough user grouping can easily be conducted based on such information. However, not all people put their personal information on the Internet. Also, in many cases, the information filled out by users is not necessarily true and comprehensive. Therefore, it is very difficult to gain a true profile for each user.

In another method, users are grouped according to information in social networks. For example, social networks can provide information about the community, hobby groups, friend groups, and the like. With regard to such information, the relationship between users is fixed. For example, two users can belong to the same friend group. However, two users in the same friend group can have different backgrounds and requirements. Therefore, it is impossible to realize targeted user grouping based solely on a fixed relationship between users. In another method, users' behaviors on the Internet are grouped. For example, users are grouped by which users have browsed the same webpage, purchased the same products, and so on. However, as mentioned above, users who bought the same product can have different purchasing motives. For that reason such common behaviors cannot be accurately associated to the users' backgrounds and requirements.

Therefore, a solution is desired that can group users more accurately based on the users' backgrounds and requirements, thus facilitating more targeted follow-up analysis and services for different groups of users. In view of the issues raised above, the present invention provides a solution that can group network users effectively so that grouping results accurately reflect users' role characteristics.

### SUMMARY OF THE INVENTION

Accordingly, one aspect of the present invention provides a computer implemented method of grouping users on a network, wherein the computer includes a processor communicatively coupled to a memory, the method including the steps of: acquiring comments posted by a user on the network; extracting a set of triples from the comments, the set of triples including at least one triple including the user's concerned aspect, the user's sentiment on the aspect, and reasons for the sentiment; creating a characteristic representation of the comments based on the set of triples; and categorizing the user into a specific user group based on the characteristic representation.

Another aspect of the present invention provides a computer implemented method of processing user grouping information, wherein the computer includes a processor communicatively coupled to a memory, the method including the steps of: acquiring grouping information of grouping a plurality of users on a network through the method of steps including: acquiring comments posted by a user on the network; extracting a set of triples from the comments, the set of triples including at least one triple including the user's concerned aspect, the user's sentiment on the aspect, and reasons for the sentiment; creating a characteristic representation of the comments based on the set of triples; and categorizing the user into a specific user group based on the characteristic representation; processing the grouping information to acquire relevant information associated with a user group; and displaying, in association with the user group, the relevant information.

Another aspect of the present invention provides an apparatus for grouping users on a network, the apparatus including: a comment acquiring unit configured to acquire comments posted by a user on the network; a triple set acquiring unit configured to extract a set of triples from the comments, the set of triples including at least one triple including the user's concerned aspect, the user's sentiment on the aspect, and reasons for the sentiment; a characteristic representation creating unit configured to create a characteristic representation of the comments based on the set of triples; and a grouping unit configured to categorize the user into a specific user group based on the characteristic representation.

Another aspect of the present invention provides an apparatus for processing user grouping information, the apparatus including: a grouping information acquiring unit configured to acquire grouping information of grouping a plurality of users on a network through the apparatus including: a comment acquiring unit configured to acquire comments posted by a user on the network; a triple set acquiring unit configured to extract a set of triples from the comments, the set of triples including at least one triple including the user's concerned aspect, the user's sentiment on the aspect, and reasons for the sentiment; a characteristic representation creating unit configured to create a characteristic representation of the comments based on the set of triples; and a grouping unit configured to categorize the user into a specific user group based on the characteristic representation; a relevant information acquiring unit configured to process the grouping information to acquire relevant information associated with a user group; and a displaying unit configured to display, in association with the user group, the relevant information.

### BRIEF DESCRIPTION OF THE SEVERAL VIEWS OF THE DRAWINGS

FIG. 1 is a block diagram showing a hardware configuration of an exemplary computer system which implements the embodiments of the present invention.

FIG. 2 is a flowchart of a method of user grouping according to an embodiment of the present invention.

FIG. 3 is a flowchart showing steps of creating characteristic representations according to an embodiment of the present invention.

FIG. 4 shows a method of processing user grouping information according to an embodiment of the present invention.

FIG. 5 shows a schematic diagram of relevant information displayed according to an embodiment of the present invention.

FIG. 6 shows a block diagram of an apparatus for user grouping according to an embodiment of the present invention.

FIG. 7 shows a block diagram of an apparatus for processing user grouping information according to an embodiment of the present invention.

### DETAILED DESCRIPTION OF THE PREFERRED EMBODIMENT

With the use of the method and apparatus of the embodiments of the present invention, users can be grouped based on user concerned aspects, given sentiments, and reasons for the given sentiments in comments posted by the users on the network. The resulting user groups can better reflect the users' backgrounds and requirements and more accurately express the users' role characteristics. Also, the embodiments of the present invention can better handle and utilize the obtained user grouping information.

Through the more detailed description of some embodiments of the present invention in the accompanying drawings, the objects, features, and advantages of the present invention are made more apparent. However, the present invention can be implemented in various manners and should not be construed to be limited to the embodiments disclosed herein. On the contrary, these embodiments are provided for the thorough and complete understanding of the present invention to convey the scope of the present invention to those skilled in the art. Generally, the same reference refers to the same components in the embodiments of the present invention.

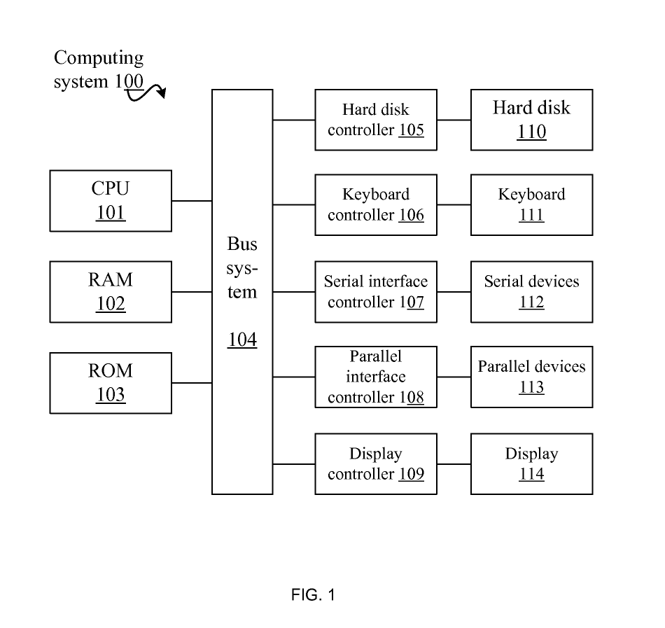

FIG. 1 shows an example of a computer system 100 which implements the embodiments of the present invention. As shown in FIG. 1, computer system 100 can include a CPU (Central Process Unit) 101, RAM (Random Access Memory) 102, ROM (Read Only Memory) 103, system bus 104, hard drive controller 105, keyboard controller 106, serial interface controller 107, parallel interface controller 108, display controller 109, hard drive 110, keyboard 111, serial peripheral equipment 112, parallel peripheral equipment 113, and display 114. CPU 101, RAM 102, ROM 103, hard drive controller 105, keyboard controller 106, serial interface controller 107, parallel interface controller 108, and display controller 109 are all coupled to system bus 104. Hard drive 110 is coupled to hard drive controller 105 and keyboard 111 is coupled to keyboard controller 106. Serial peripheral equipment 112 is coupled to serial interface controller 107 and parallel peripheral equipment 113 is coupled to parallel interface controller 108. Display 114 is coupled to display controller 109. The structure as shown in FIG. 1 is only for exemplary purposes rather than a limitation to the present invention. In some cases, some devices can be added to or removed from the computer system 100 based on specific situations.

As will be appreciated by one skilled in the art, aspects of the present invention can be embodied as a system, method, or computer program product. Accordingly, aspects of the present invention can take the form of an entirely hardware embodiment, an entirely software embodiment (comprising firmware, resident software, micro-code, etc.), or an embodiment combining both software and hardware aspects that can all generally be referred to herein as a “circuit,” “module,” or “system.” Furthermore, aspects of the present invention can take the form of a computer program product embodied in one or more computer readable mediums having computer readable program code embodied thereon.

Any combination of one or more computer readable mediums can be utilized. The computer readable medium can be a computer readable signal or storage medium. A computer readable storage medium can be, for example but is not limited to, an electronic, magnetic, optical, electromagnetic, infrared or semiconductor system, apparatus or device, or any suitable combination of the foregoing. More specific examples of the computer readable storage medium can include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain or store a program for use by or in connection with an instruction execution system, apparatus, or device.

A computer readable signal medium can include a propagated data signal with computer readable program code embodied therein (for example, in baseband or as part of a carrier wave). Such a propagated signal can take any of a variety of forms including, but not limited to, electro-magnetic, optical, or any suitable combination thereof. A computer readable signal medium can be any computer readable medium that is not a computer readable storage medium and that can communicate, propagate, or transport a program for use by or in connection with an instruction execution system, apparatus, or device. Program code embodied on a computer readable medium can be transmitted using any appropriate medium including, but not limited to, wireless, wireline, optical fiber cable, RF, etc., or any suitable combination of the foregoing.

Computer program code for carrying out operations for aspects of the present invention can be written in any combination of one or more programming languages including, but not limited to, an object oriented programming language (such as Java, Smalltalk, or C++) and conventional procedural programming languages (such as the “C” programming language or similar programming languages). The program code can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider).

Aspects of the present invention are described below with reference to flowchart illustrations and/or block diagrams of methods, apparatuses (systems), and computer program products according to embodiments of the present invention. Each block of the flowchart illustrations and/or block diagrams and combinations of blocks in the flowchart illustrations and/or block diagrams can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions/behaviors specified in the flowchart and/or block diagram block or blocks.

These computer program instructions can also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions can also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/behaviors specified in the flowchart and/or block diagram block or blocks.

Implementations of the present invention are now specifically described. In order to group network users more effectively, the inventor of the present invention performed research and analysis on various behaviors of users on the network. The inventor found that comments directed to some product or service posted by the users on the network provided hints regarding the users' role characteristics and can be used as a basis for user grouping. For example, a user can post the following comments targeted to a hotel: “as a business man, this hotel is really the best choice in this city.” Based on such comments, it can be learned that the role of this user is a business man so that the user shall be put into a group of business men. However, in most cases, user comments are not that explicit. By further analyzing user comments, the inventor found that, with respect to a same product or service, concerned aspects of users with different backgrounds and requirements are different. For example, for a hotel, business men may care more about the network, telephone, office environment and the like, couples in trips may care more about comfortable beds, a beautiful environment, service quality and the like, and for singles, wonderful activities and TV programs may be more attractive. Also, for the same concerned aspect, sentiments given by users with different backgrounds and requirements can be completely different. For example, for the same aspect—appearance—of a same cell phone, avant-garde people may feel that it is very fashionable while conservative people may feel that it is unacceptable. Further, even if people give the same sentiment on the same aspect, they may have different reasons. For example, a business man may want a big room to have meeting, while a family wants a big room so that the children have space to play. From the above examples, user concerned aspects, sentiments with respect to the aspects, and reasons for the sentiments can be found and provide information for accurately positioning user role characteristics. Therefore, in the embodiments of the present invention, users are grouped based on user comments posted on the network. More specifically, users can be grouped based on information of the above three aspects reflected in the comments.

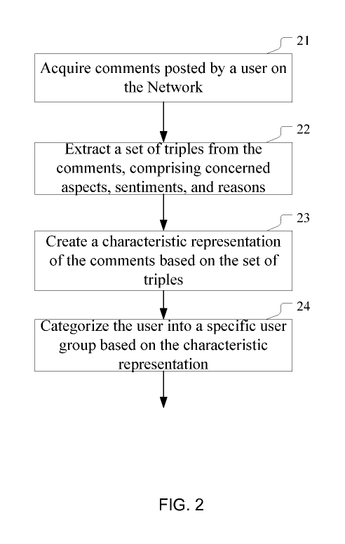

FIG. 2 is flow chart of a method of user grouping according to one embodiment of the invention under the guidance of the above inventive concept. Shown in FIG. 2, the method of the embodiment can include the following steps: step 21, acquiring comments posted by a user on the network; step 22, extracting a set of triples from the comments, the set of triples including at least one triple including the user's concerned aspect, the user's sentiment on the aspect, and reasons for the sentiment; step 23, creating a characteristic representation of the comments based on the set of triples; and step 24, categorizing the user into a specific user group based on the characteristic representation. The execution of the steps is described below in conjunction with specific examples.

First, in step 21, comments posted by a user for a specific product or service on the network are acquired. In the prior art, many applications that provide products or services through the network (such as e-shopping websites, product or service rating websites etc.) allow users to post their own reviews and opinions. Such reviews and opinions can be provided in many forms. In a specific example, with respect to services of a hotel, a plurality of users reviews them on the network. The reviews contain score sentiments given by users for a certain item (for example, 5 scores for comfort, 3 scores for price performance ratio, 4 scores for location, etc.) and comments in the form of text entered by users. Since such comments in the form of text better reflect the users' unique role characteristics, in step 21 comment information in the form of text posted by users is captured. Since these comments are posted on the web, the comment information can be acquired through simple data reading. Or, in another example, user reviews and opinions will be stored in a server of an application providing rating service. In this case, the comment information posted by users can also be read directly from the above server.

Then, in step 22, a set of triples is extracted based on the acquired user comments, wherein at least one triple consists of a user concerned aspect, user sentiment on the aspect, and reasons for the sentiment. Specifically, in one embodiment of the present invention, with respect to the comment text acquired in step 21, natural language processing and semantic analysis is performed to acquire a set of triples. A typical triple contains the following three elements: a concerned aspect, sentiment on the aspect, and reasons. However, for some aspects, users may only give sentiments without specific reasons. In this case, the corresponding triple may contain only two meaningful elements and the third element is null. Such triple can be called an incomplete triple. In order to better analyze users' role characteristics, in one embodiment, the obtained set of triples comprises at least one typical triple.

The execution of this step is described now in conjunction with several specific network comments. Assume that in step 21, the following two comment texts are acquired:
Comments A from User A: “the hotel is good, with wifi provided, free and fast Internet . . . big room, not crowded even if several people have a meeting in the room; the hotel also has a swimming pool and you may relax yourself outside of work . . . ”
Comments B from User B: “the hotel environment is very good, with a free garden next to it, you can quickly walk over; there is a swimming pool next to the garden, suitable for a family to play together . . . a plenty of room suitable for kids who like to play around in the room . . . ”
   For the above comment texts, natural language processing and semantic analysis is performed. In the prior art, there have been provided multiple methods of natural language processing and methods of semantic analysis and all of these methods can be applied to the steps of the embodiment of the present invention. Since natural language processing and semantic analysis itself are not the key point of the embodiment of the present invention, the detailed description thereof is omitted.

Through the natural language processing on the comment texts, multiple keywords can be extracted. For example, for comments A, the following keywords may be extracted: <hotel, good, wifi, free, network, fast, room, big, meeting, (not) crowded, swimming pool, work, relax . . . >. In conjunction with semantic analysis of the context of the keywords, a set of multiple triples A related to user experience can be obtained:

<(Hotel, good, N/A)
(Wifi, provided, N/A)
(Internet, free, N/A)
(Internet, fast, N/A)
(Room, big, N/A)
(Room, (not, crowded), (several people, meeting))
(Swimming pool, have, (work, relax)), . . .>

In the above set A, each row shows one triple. The form of the triple is (concerned aspect, sentiment, reasons). However, the last element of part of the triples is null (that is not available, represented by N/A) and these are incomplete triples. In the set of triples A shown above, the last two triples are typical triples, while the other triples are incomplete triples.

Similarly, for Comments B, the following set of triples B may be extracted through natural language processing and semantic analysis:

<(Hotel environment, good, N/A)
(Garden, have, N/A)
(Garden, Free, N/A)
(Walk over, quickly, N/A)
(Swimming pool, have, (a family, play))
(Room, big, (play around, kids)), . . .>

For other comment texts, sets of triples reflecting user role characteristics may be obtained similarly.

Then, in step 23, characteristic representations of the comments are created based on the above obtained set of triples. In one embodiment of the present invention, the obtained set of triples will be organized into a matrix form, which is taken as a characteristic matrix of the corresponding comments (i.e., one kind of a characteristic representation). Specifically, in one example, the above set of triples can be organized into a 3*m matrix, where m is the number of triples in the set. In other examples, a set of triples can also be organized into a matrix with other formats.

In the above characteristic matrix, most of the elements consist of various terms or words. This brings some difficulties to the further calculation of the characteristic matrix. In order to simplify the matrix calculation, in one embodiment of the present invention, in step 23, a set of triples is first reduced through a simple basic semantic processing to simplify the set of triples and then a simplified characteristic matrix is created based on the simplified set of triples. Specifically, multiple words with similar meaning in the first elements of the triples can be reduced into the same term and the second elements in the triples—user sentiments—are reduced into positive or negative sentiments. For example, in one example, for the set of triples A, “wifi” and “Internet” are reduced into “Internet” and “good”, “provided”, “free”, “fast,” and the like are reduced into positive sentiments. In this way, the previously described set A can be simplified into the following form of set A′:

<(Hotel, positive, N/A)
(Internet, positive, N/A)
(Internet, positive, N/A)
(Internet, positive, N/A)
(Room, positive, N/A)
(Room, positive, (several people, meeting))
(Swimming pool, positive, (work, relax)), . . .>

For the set B, similar reduction and simplification can also be conducted. Compared to the original set of triples, the simplified set greatly reduces the number of different elements that need to be processed. A simplified characteristic matrix formed on the basis of the simplified set of triples is more conducive for the subsequent calculation and processing.

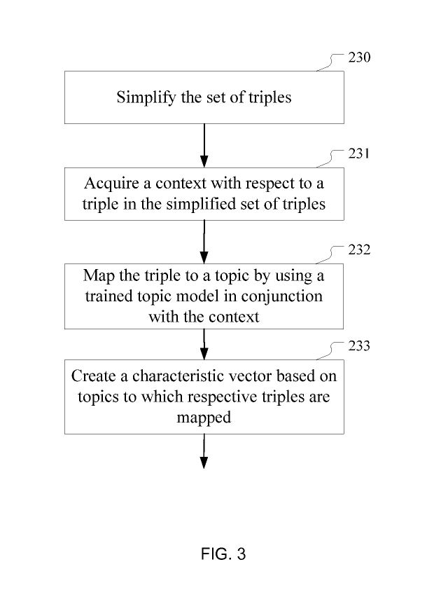

To further optimize the creation and comparison of characteristic representations, in one embodiment of the present invention, characteristic representations in the form of vectors are created through two levels of reduction and simplification. That is, characteristic vectors are created as characteristic representations for the comments based on the set of triples. FIG. 3 shows steps of creating characteristic representations according to one embodiment of the invention. That is, sub-steps of the step 23 in FIG. 2. Referring to FIG. 3, the method of creating the characteristic representations includes: step 230, simplifying the set of triples; step 231, with respect to the triples in the simplified set of triples, acquiring the context thereof; step 232, in conjunction with the context, mapping the triples to topics by using a trained topic model; and step 233, creating a characteristic vector based on the topics to which the respective triples in the set of triples are mapped.

Specifically, step 230 is executed through simple basic semantic processing. This step is the same as the reduction and simplification procedure specifically described in conjunction with set A. Then, in step 231, with respect to the simplified triples, the context thereof is obtained. Information of the context mainly includes adjacent triples (concerned aspects, sentiments, reasons), noun phrases and verb phrases in the context, and conjunctions (such as, “but”, “however”, “similarly”, “also”, etc.).

Then, in step 232, the triple is combined with the context and is mapped to a topic with the use of the trained topic model. The training of the topic model can be executed in a variety of ways. For example, a concept of Latent Semantic Analysis (LSA) is proposed in Journey of the American Society for Information Science, 1990. Typically, LSA can map a high-dimensional count vector, for example, a vector arising in vector space representations of text documents, to a lower-dimensional representation. Thus, in one embodiment of the present invention, the LSA method can be used to analyze multiple triples, the corresponding context, and the reflected topic so as to train the topic model, through which the association between the triple and topic in the context is reflected.

With the use of such trained topic model, the respective triples in the set A′ can be mapped in conjunction with the context to the corresponding topics. Specifically, based on the basic concept of LSA that Thomas Hofmann proposed in 1999 probabilistic latent semantic analysis, i.e., pLSI. In addition, David M. Blei, et al, proposed in a solution of Latent Dirichlet Allocation (LDA) in 2003. The above pLSI solution and LDA solution can both be used to execute the above mentioned mappings. Specifically, in one embodiment of the present invention, each triple in the set A′ is regarded as a term, the context of the triple is regarded as a document, and the pLSI method or LDA method is executed to deal with the association between the term and the document so as to map the triple to a topic based on the topic model in conjunction with the context. In one embodiment of the present invention, the mapping result can be used to further train or optimize the topic model. Thus, in the process of continuously analyzing more comments, the topic model can be gradually improved and also provides a better basis for the analysis of follow-up comments. Those skilled in the art can appreciate that the methods related to semantic analysis and topic modeling listed above are well known methods in prior art. Besides, the prior art also proposes further methods on this basis or different methods. Such methods can similarly be used for topic modeling and the mapping of topic.

Where the topics to which the respective triples are mapped are obtained, in step 233 a characteristic vector is created according to the obtained topics and the characteristic vector can be used as a characteristic representation of the corresponding comments. In one embodiment of the present invention, a characteristic vector is created by directly using the obtained respective topics as elements of the vector. For example, for the simplified set of triples A′, by executing step 232, the triple (network, positive, N/A) is mapped to a topic T1, the triple (space, positive, (several people, meeting)) is mapped to a topic T2, the triple (swimming pool, positive, (work, relax)) is mapped to a topic T3, and so on. Thus, in step 233, a vector (T1, T2, T3) can be directly obtained as a characteristic representation of the comments A based on the mapped topics T1, T2, and T3.

In another embodiment, a topic vector VT is pre-created, which contains the set of topics that can arise, for example VT=(T1, T2, T3, T4, T5 . . . ). The number of elements in the topic vector is related with the set of terms defined in the topic modeling algorithm. When creating the characteristic vector based on the mapped topics, the mapped topics are compared to the elements in the topic vector VT. If the i-th element in the topic vector VT (i.e., the topic Ti) also appears in the mapping-obtained topics, the i-th element in the characteristic vector will be increased by 1, otherwise it will be maintained at 0, whereby the characteristic vector may be obtained, whose dimension equals to that of the topic vector. For example, if topics T1, T2, and T3 are obtained by mapping the triples in the set of triples A′, then by comparing with the topic vector VT, a characteristic vector v=(1, 1, 1, 0, 0, . . . ) can be obtained. In one embodiment, the element i in the characteristic vector can also be greater than 1, to show the weight of the corresponding topic Ti. Therefore, the characteristic vector thus obtained actually reflects the results of the comparison or difference of the mapping-obtained topics with topics in the vector VT. Although the dimension of the characteristic vector can be relatively large, because all its elements are numeric, follow-up inter-vector calculation can be simplified.

In addition to the characteristic vector creation method described above, based on well known vector knowledge, those skilled in the art are able to adopt other means to organize and transform mapping-obtained multiple topics, so as to create characteristic vectors in other forms as characteristic representations of the comments. In some embodiments, the topic mapping can be conducted directly based on the original set of triples to obtain a characteristic vector with topic as element. In addition, although the embodiment in which the characteristic matrix and the characteristic vector are used as characteristic representations of the comments is described specifically hereinabove, it can be understood that the form of the characteristic representation is not limited to the characteristic matrix and the characteristic vector. By reading the specification, those skilled in the art can obtain more forms of characteristic representations based on the set of triples, such as charts, tables and so on.

Where the characteristic representations of the comments are obtained, users posting the comments may be grouped, that is, step 24 of FIG. 2 is executed, in which users are categorized to specific user groups based on the created characteristic representations. In one embodiment of the present invention, the characteristic representation is in the form of vector. In this case, in step 24, the similarity or distance between different characteristic vectors can be calculated for user grouping. Specifically, in one embodiment, the distance between the characteristic vector and a representative vector of an existing user group can be calculated. If it is found through calculation that the distance between the characteristic vector and the representative vector of a certain user group is less than a predetermined threshold, then the user corresponding to the characteristic vector should be categorized into the certain user group. Otherwise, the characteristic vector is compared to a next user group continuously. If the distance between the characteristic vector and the representative vector of each of the existing user groups is greater than the predetermined threshold, then the user corresponding to the characteristic vector is placed into a new group and the characteristic vector is used as the representative vector of the new group. Or, by calculating the distance between the characteristic vector and the representative vector of each of the existing user groups one by one, the user corresponding to the characteristic vector is categorized into a user group with the shortest distance.

For example, assume the characteristic vector of comments A posted by User A is v and the existing user groups include groups 1-4 with representative vectors v1-v4, respectively. In one example, the distances between vector v and the respective representative vectors v1-v4 are calculated to determine to which group User A should be categorized. If the distance between v and a certain representative vector vi is less than a predetermined threshold, then User A is categorized into group i. If the distance between v and each of v1-v4 is greater than the predetermined threshold, then User A is placed into a new group 5.

In one embodiment, the above-mentioned plurality of existing user groups (e.g. groups 1-4) are pre-designed before the execution of user grouping and the representative vector of each group can be pre-designated. In another embodiment, the plurality of existing user groups is created gradually and dynamically during the process of continuous user grouping. In one example, a representative vector of a user group is an average of characteristic vectors corresponding to all users in the group. In another example, a representative vector of a user group is a characteristic vector corresponding to any user in the group. In one embodiment, along with the update of the user groups, for example, with a new user being placed therein, the representative vector of the user group can be updated.

In one implementation, user grouping is performed by calculating the similarity between the characteristic vector and a representative vector of an existing group. When the similarity of the characteristic vector with a representative vector of a certain group exceeds a predetermined threshold, the user corresponding to the characteristic vector is placed into this group. It can be appreciated that there are many algorithms in the prior art to calculate the distance or similarity between vectors. These algorithms can be used for the characteristic vector and representative vector of the embodiments of the present invention. Based on the calculated distance or similarity, the user can be placed to a specific user group as described above.

In one embodiment of the present invention, the characteristic representation is in the form of a characteristic matrix. In this case, in step 24, the similarity between different characteristic matrixes is determined in conjunction with semantic analysis so that a specific characteristic matrix is categorized into a certain group. The calculation of the similarity between characteristic matrixes can be realized by using a plurality of matrix comparison algorithms in the prior art in conjunction with semantic analysis. Based on the calculated similarity, a user can be placed to a specific user group through the grouping process described in conjunction with the vector distance.

As mentioned earlier, characteristic representations of comments can have other forms, such as charts, tables, etc. For other forms of characteristic representations, those skilled in the art can correspondingly adopt appropriate comparison and determination methods, so as to place the corresponding user to a specific user group based on the comparison result. Such implementation is also covered within the scope of the present invention.

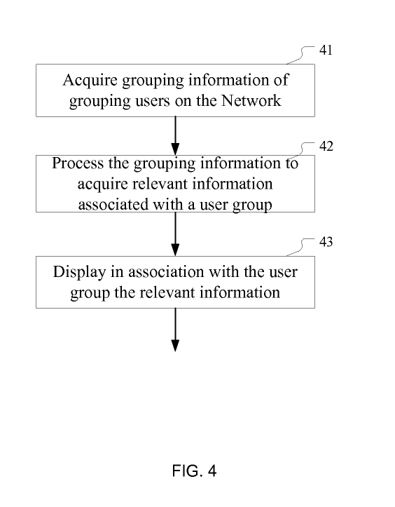

To sum up, in embodiments of the present invention, a set of triples are extracted from a user's comments, wherein at least one triplet contains a user concerned aspect, sentiment on the aspect, and reasons for the sentiment. Since comment texts are posted by the user on the web and can be easily obtained, this provides a good basis for execution of the method of the embodiment of the present invention. Where the above set of triples is acquired, a characteristic representation of the comments can be created to reflect the core feature of the comments. Next, according to the characteristic representation created with respect to the comments, the user who posted the comments is placed to a specific user group. Since the set of triples and the created characteristic representation are based on the triples, while the triples contain information of concerned aspects, sentiments, and reasons, important clues including concerned aspects, sentiments, and reasons embodied in the user's comments are considered comprehensively in user grouping according to the embodiment of the present invention. These clues are closely related to the user's backgrounds and requirements, whereby the grouping executed based on these clues can accurately reflect the role characteristics of the user.

Where user grouping is conducted with the use of the method shown in FIG. 2, user grouping results can be further processed so as to make better use of the obtained grouping information. FIG. 4 shows a method of processing user grouping information according to one embodiment of the present invention. As shown in FIG. 4, the method includes: step 41, in which grouping information that a plurality of users are grouped using the method shown in FIG. 2 is acquired; step 42, in which the grouping information is processed to acquire relevant information associated with a user group; and step 43, in which the relevant information is displayed in association with the user group.

Specifically, in step 41 grouping information obtained through grouping according to the method in FIG. 2 is acquired. Such grouping information can contain information on the resulting user groups, information on users contained in each user group, and so on. Where the grouping information is acquired, in step 42, the grouping information is processed to acquire relevant information associated with a user group. Specifically, in one embodiment, step 42 of processing the grouping information to acquire the relevant information includes extracting a core word of each user group through semantic analysis and using the core word as a semantic label of the group (i.e., relevant information associated with the user group). In one example, the obtained semantic label can be attached to the corresponding user group. For example, through the processing of user groups 1-4, a semantic label “family” can be used to mark Group 1, a semantic label “business man” for Group 2, “singles” for Group 3 and “student” for Group 4.

In another embodiment, step 42 includes obtaining hot attribute words of each user group, namely, words that best reflect user characteristics in the group, by analyzing keywords of user comments in each user group. For example, through further analysis and processing of the above groups, it can be obtained that hot attribute words of the “family” group include “family”, “children”, “parent” and the like, hot attribute words of the “business man” group include “business”, “male”, “colleague” and the like, hot attribute words of the “singles” group include “single”, “myself”, “female” and the like, and hot attribute words of the “student” group include “student”, “friends”, “classmate” and the like.

In another embodiment, step 42 also includes obtaining hot concerns of each user group, namely, words that best reflect user concerned aspects in the group, by analyzing keywords of user concerned aspects in each user group. For example, through analysis and processing of concerned aspects of the above groups, it can be obtained that, hot concerns of the “family” group include “bed”, “room size”, “transportation” and the like, hot concerns of the “business man” group include “network”, “telephone” and “desktop” and the like, hot concerns of the “singles” group include “TV”, “activities”, “bar” and the like, and hot concerns of the “student” group include “price”, “transportation”, “eating place” and the like.

In another embodiment, step 42 also includes, by analyzing user sentiments on hot concerned aspects in each user group, obtaining the distribution of sentiments on hot concerns of the group. For example, by reading and counting sentiments on hot concern “bed” given by users in the “family” group, it can be learned that 60% of users in the group give positive sentiments and 40% of users give negative sentiments. In one embodiment, average sentiments on hot concerns of the entire group can also be obtained based on the distribution of the above sentiments. For example, the average sentiments on hot concern “bed” of the “family” group can be expressed as 60%.

In one embodiment, step 42 also includes analyzing reasons why users in each user group give the sentiments and extracting keywords therefrom so as to obtain hot reasons of each user group, namely, words that best reflect reasons why users give corresponding sentiments in the group. For example, through analysis and processing of the sentiment reasons of the above groups, it can be obtained that hot reasons of the “family” group include “vacation”, “kitchen”, “swim”, “parking” and the like, hot reasons of the “business man” group include “meeting”, “conference”, “hot water” and “taxi” and the like, hot reasons of the “singles” group include “relax”, “drink”, “music” and the like, and hot reasons of the “student” group include “not expensive”, “reunion”, “bus station”, “summer holiday” and the like.

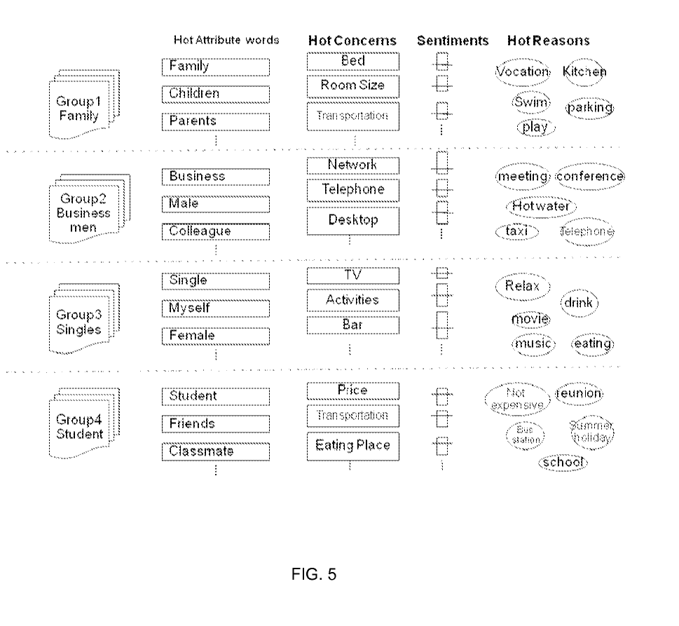

On the basis of all relevant information obtained in step 42, the information can be displayed in association with the user group. That is, step 43 is executed. FIG. 5 shows a schematic diagram of relevant information displayed according to one embodiment of the invention. As shown in FIG. 5 for the groups 1-4 described above, relevant information associated with each group is obtained by further processing of grouping information, and the relevant information includes the semantic label, the hot attribute words, the hot concerns, the entire sentiments, and the hot reasons described above. All the relevant information is information that reflects characteristics of the user group itself. In FIG. 5, the information is displayed in association with the corresponding user group, so as to more clearly show the characteristics of each user group. As a result, the user grouping results can be exhibited more intuitively. It can be appreciated that although a plurality of relevant information reflecting the characteristics of the user groups is listed above, such kind of relevant information is apparently not limited to the above description. The displaying of the relevant information is not limited to a specific style shown in FIG. 5 either. In some embodiments, it is possible that only a part of the relevant information is acquired/displayed.

In one embodiment of the present invention, user comments from a specific user group can also be acquired as the relevant information. Specifically, in step 42, the comments issued by respective users in a specific user group can be read and in step 43 the comments are displayed in association with the user group. This embodiment provides the possibility of displaying user comments by group. For example, in the four groups described above, a student can choose to only browse comments from the group with a semantic label “students” so as to obtain more targeted information.

Although the examples of further processing grouping information to obtain and display relevant information are specifically described above, the way of further processing grouping information and the content of the obtained relevant information is not limited to the above embodiments. By reading this specification, those skilled in the art can use more ways to acquire relevant information of more contents according to needs, so as to better display and use the grouping results in FIG. 2.

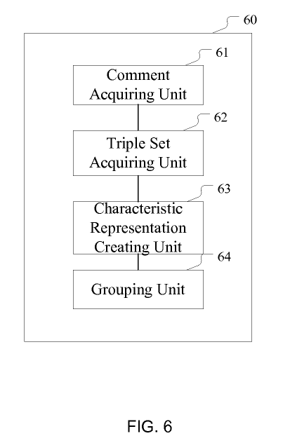

Based on the same inventive concept, the embodiments of the present invention also provide an apparatus for user grouping. FIG. 6 shows a block diagram of an apparatus for user grouping according to one embodiment of the invention. As shown in FIG. 6, the apparatus is generally shown as 60 and includes: a comment acquiring unit 61 configured to acquire comments posted by a user on the network; a triple set acquiring unit 62 configured to extract a set of triples from the comments, the set of triples including at least one triple comprising the user's concerned aspect, the user's sentiment on the aspect, and reasons for the sentiment; a characteristic representation creating unit 63 configured to create a characteristic representation of the comments based on the set of triples; and a grouping unit 64 configured to categorize the user into a specific user group based on the characteristic representation.

In one embodiment, the characteristic representation creating unit 63 is configured to create a characteristic representation in a matrix form based on the set of triples. In another embodiment, the characteristic representation creating unit 63 is configured to create a characteristic representation in a vector form. To this end, the characteristic representation creating unit 63 can realize the creation of the characteristic vector through its sub-unit or module. Specifically, in one example, the characteristic representation creating unit 63 further includes (not shown): a simplifying module configured to simplify the set of triples; a context acquiring module configured to, with respect to the triples in the simplified set of triples, acquire the context thereof; a topic mapping module configured to map the triples to topics using a trained topic module in conjunction with the context; and a vector creating module configured to create a characteristic vector based on the topics to which the respective triples in the set of triples are mapped.

Based on the characteristic representations created by the characteristic representation creating unit 63, the grouping unit 64 can categorize users by calculating the similarity or distance between different characteristic representations.

The specific implementation of each unit of the apparatus 60 corresponds to the description of the grouping method with reference to FIG. 2 in combination with the specific examples and is not detailed here.

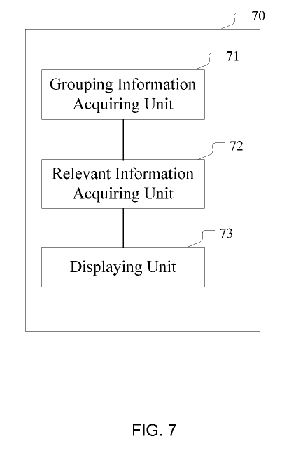

According to the embodiment of another aspect of the present invention, there is also provided an apparatus for processing user grouping information. FIG. 7 shows a block diagram of an apparatus for processing user grouping information according to one embodiment of the present invention. As shown in FIG. 7, the apparatus is generally shown as 70 and includes: a grouping information acquiring unit 71 configured to acquire grouping information of grouping a plurality of users on a network through the apparatus shown in FIG. 6; a relevant information acquiring unit 72 configured to process the grouping information to acquire relevant information associated with a user group; and a displaying unit 73 configured to display, in association with the user group, the relevant information.

In one embodiment, the relevant information acquiring unit 72 is configured to analyze the grouping information to acquire at least one of the following information items associated with the user group: the semantic label of the user group, the hot attribute words, the hot concerns, the entire sentiments, and the hot reasons. Accordingly, the displaying unit 83 is configured to display the at least one of the information items in association with the user group. In another embodiment, the relevant information acquiring unit 72 is configured to read the comments associated with the user group. Accordingly, the displaying unit 73 is configured to display the user comments by group.

The specific implementation of each unit of the apparatus 70 corresponds to the description of the method with reference to FIG. 4 in combination with the specific examples and is not detailed here.

To sum up, through the embodiments of the present invention, users can be grouped based on user concerned aspects, given sentiments, and reasons for the given sentiments embodied in comments posted by the users on the network. The resulting user groups can better reflect the users' backgrounds and requirements and more accurately express the users' role characteristics. Also, the embodiments of the present invention can better handle and utilize the obtained user grouping information by acquiring and displaying the relevant information associated with user groups.

The flowcharts and block diagrams in the Figures illustrate the architecture, functionality, and operation of possible implementations of systems, methods, and computer program products according to various embodiments of the present invention. In this regard, each block in the flowcharts or block diagrams can represent a module, segment, or portion of code, which comprises one or more executable instructions for implementing the specified logical functions. It should also be noted that, in some alternative implementations, the functions noted in the block can occur out of the order noted in the Figures. For example, two blocks shown in succession can, in fact, be executed substantially concurrently or the blocks can sometimes be executed in the reverse order depending upon the functionality involved. It will also be noted that each block of the block diagrams and/or flowchart illustration and combinations of blocks in the block diagrams and/or flowchart illustrations can be implemented by special purpose hardware-based systems that perform the specified functions or behaviors or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application, or technical improvement over technologies found in the marketplace or to enable others of ordinary skill in the art to understand the embodiments disclosed herein.

What is claimed is:

1. A computer implemented method of grouping users on a network, wherein the computer includes a processor communicatively coupled to a memory, the method comprising:
acquiring comments posted by a user on the network;
extracting a set of triples from the comments, the set of triples comprising at least one triple comprising the user's concerned aspect, the user's sentiment on the aspect, and reasons for the sentiment;
creating a characteristic representation of the comments based on the set of triples; and
categorizing the user into a specific user group based on the characteristic representation.

2. The computer implemented method according to claim 1, wherein the characteristic representation of the comments is a characteristic matrix and the categorizing the user into a specific user group based on the characteristic representation comprises locating the user to a specific user group based on the similarity between different characteristic matrixes.

3. The computer implemented method according to claim 1, wherein the characteristic representation of the comments is a characteristic vector and the categorizing the user into a specific user group based on the characteristic representation comprises locating the user to a specific user group based on the distance or similarity between different characteristic vectors.

4. The computer implemented method according to claim 3, wherein, the creating a characteristic representation comprises:
acquiring a context of a triple in the set of triples;
in conjunction with the context, mapping the triple to a topic by using a trained topic model; and
creating a characteristic vector based on topics to which respective triples in the set of triples are mapped.

5. The computer implemented method according to claim 4, wherein, the creating a characteristic vector comprises:
using the topics to which respective triples in the set of triples are mapped as elements of the characteristic vector; or
using difference between the topics to which respective triples in the set of triples are mapped and topics in a pre-created topic vector as elements of the characteristic vector.

6. The computer implemented method according to claim 5, wherein the creating a characteristic representation of the comments further comprises simplifying the set of triples.

7. The computer implemented method according to claim 6, wherein, the simplifying the set of triples comprises:
in the set of triples, reducing multiple words with similar semantics in user concerned aspects to a same term; and
reducing the sentiments to a positive sentiment or a negative sentiment.

8. A computer implemented method of processing user grouping information, wherein the computer includes a processor communicatively coupled to a memory, the method comprising:
acquiring grouping information of grouping a plurality of users on a network;
acquiring comments posted by a user on the network; extracting a set of triples from the comments, the set of triples comprising at least one triple comprising the user's concerned aspect, the user's sentiment on the aspect, and reasons for the sentiment;
creating a characteristic representation of the comments based on the set of triples;
categorizing the user into a specific user group based on the characteristic representation;
processing the grouping information to acquire relevant information associated with a user group; and
displaying, in association with the user group, the relevant information.

9. The computer implemented method according to claim 8, wherein the relevant information comprises one or more of the following: semantic labels of the user group, hot attribute words, hot concerns, entire sentiments, and/or hot reasons.

10. The computer implemented method according to claim 8, wherein the relevant information comprises the comments posted by users from the user group.

11. An apparatus of grouping users on a network, comprising:
a comment acquiring unit configured to acquire comments posted by a user on the network;
a triple set acquiring unit configured to extract a set of triples from the comments, the set of triples comprising at least one triple comprising the user's concerned aspect, the user's sentiment on the aspect, and reasons for the sentiment;
a characteristic representation creating unit configured to create a characteristic representation of the comments based on the set of triples; and
a grouping unit configured to categorize the user into a specific user group based on the characteristic representation.

12. The apparatus according to claim 11, wherein the characteristic representation of the comments is a characteristic matrix and the grouping unit is configured to place the user to a specific user group based on the similarity between different characteristic matrixes.

13. The apparatus according to claim 11, wherein the characteristic representation of the comments is a characteristic vector and the grouping unit is configured to place the user to a specific user group based on the distance or similarity between different characteristic vectors.

14. The apparatus according to claim 13, wherein the characteristic representation creating unit comprises:
a context acquiring unit configured to acquire a context of a triple in the set of triples;
a topic mapping module configured to, in conjunction with the context, map the triple to a topic by using a trained topic model; and
a vector creating module configured to create a characteristic vector based on topics to which respective triples in the set of triples are mapped.

15. The apparatus according to claim 14, wherein the vector creating module is configured to use the topics to which respective triples in the set of triples are mapped as elements of the characteristic vector or use difference between the topics to which respective triples in the set of triples are mapped and topics in a pre-created topic vector as elements of the characteristic vector.

16. The apparatus according to claim 15, wherein the characteristic representation creating unit further comprises a simplifying module configured to simplify the set of triples.

17. The apparatus according to claim 16, wherein the simplifying module is configured to: in the set of triples, reduce multiple words with similar semantics in user concerned aspects to a same term and reduce the sentiments to a positive sentiment or a negative sentiment.

18. An apparatus of processing user grouping information, comprising:
a grouping information acquiring unit configured to acquire grouping information of grouping a plurality of users on a network through the apparatus;
a comment acquiring unit configured to acquire comments posted by a user on the network;
a triple set acquiring unit configured to extract a set of triples from the comments, the set of triples comprising at least one triple comprising the user's concerned aspect, the user's sentiment on the aspect, and reasons for the sentiment;
a characteristic representation creating unit configured to create a characteristic representation of the comments based on the set of triples;
a grouping unit configured to categorize the user into a specific user group based on the characteristic representation;
a relevant information acquiring unit configured to process the grouping information to acquire relevant information associated with a user group; and
a displaying unit configured to display, in association with the user group, the relevant information.

19. The apparatus according to claim 18, wherein the relevant information comprises one or more of the following: semantic label of the user group, hot characteristic words, hot concerns, entire sentiments, and/or hot reasons.

20. The apparatus according to claim 18, wherein the relevant information comprises the comments posted by users from the user group.
